(19) United States
(12) Patent Application Publication
(10) Pub. No.: US 2025/0187494 A1
(43) Pub. Date: Jun. 12, 2025

(54) BALANCING CONTROL FOR DISTRIBUTED LOW VOLTAGE SYSTEM WITH BIDIRECTIONAL CONVERTERS TO SUPPORT MULTIPLE LOW VOLTAGE BUSSES

(71) Applicant: GM Global Technology Operations LLC, Detroit, MI (US)

(72) Inventors: Jun-mo Kang, Ann Arbor, MI (US); Chen-fang Chang, Bloomfield Hills, MI (US)

(21) Appl. No.: 18/533,420

(22) Filed: Dec. 8, 2023

(51) Int. Cl. B60L 58/22; B60L 58/12; H02J 7/00

(52) U.S. Cl. CPC B60L 58/22; H02J 7/0019; H02J 7/00716; B60L 58/12; B60L 2240/547; B60L 2240/549

(57) ABSTRACT

A vehicle includes a battery pack and performs a method of balancing charge in the battery pack. The battery pack includes a first module group coupled to a first low voltage bus, a second module group coupled to a switch, a third module group coupled to a second low voltage bus, and a processor. The processor is configured to couple the second module group to the first low voltage bus via the switch in a first configuration during a first phase of a cycle to transfer a charge between the first module group and the second module group, and couple the second module group to the second low voltage bus via the switch in a second configuration during a second phase of the cycle to transfer charge between the second module group and the third module group to thereby balance the charge in the battery pack.

### INTRODUCTION

The subject disclosure relates to operation of an electrical system in a vehicle and, in particular, to a system and method for balancing the state of charge between battery modules of a battery pack of the vehicle by controlling a switch between the battery pack and one or more low voltage loads of the vehicle.

An electric vehicle operates using an electric system having a battery pack. The battery pack includes a plurality of module groups, each having battery modules therein. The battery pack provides power both to high voltage loads, such as the motor, etc. and low voltage loads, such as radio, dashboard, etc. During operation of the vehicle, the state of charge of each module group can vary, causing divergence between the states of charge across the module groups of the battery pack. As the states of charge diverge, the operation of the electric system declines. Accordingly, it is desirable to provide a system and method for balancing the states of charge across the plurality of module groups.

### SUMMARY

In one exemplary embodiment, a method of balancing charge in a battery pack is disclosed. A first module group is coupled to a first low voltage bus. A second module group is coupled to a switch. A third module group is coupled to a second low voltage bus. The second module group is coupled to the first low voltage bus via the switch in a first configuration during a first phase of a cycle to transfer a charge between the first module group and the second module group. The second module group is coupled to the second low voltage bus via the switch in a second configuration during a second phase of the cycle to transfer the charge between the second module group and the third module group to thereby balance the charge in the battery pack.

In addition to one or more of the features described herein, the method further includes determining a balancing current for transferring the charge by minimizing a cost function that includes a sum of the square of charge differences and a sum of the square of balancing currents over a finite cycle horizon.

In addition to one or more of the features described herein, the method further includes determining the balancing currents which minimize an effect of balancing the module groups on at least one of a first low voltage load on the first low voltage bus and a second low voltage load on the second low voltage bus.

In addition to one or more of the features described herein, the method further includes applying a constraint to the cost function and updating the constraint for each cycle.

In addition to one or more of the features described herein, the first module group includes a first plurality of module groups and the third module group includes a second plurality of module groups.

In addition to one or more of the features described herein, the number of module groups in the first plurality of module groups is based on a power level in low voltage busses coupled to the module groups.

In addition to one or more of the features described herein, a period of the cycle is fixed.

In another exemplary embodiment, a battery pack of a vehicle is disclosed. The battery pack includes a first module group coupled to a first low voltage bus, a second module group coupled to a switch, a third module group coupled to a second low voltage bus, and a processor. The processor is configured to couple the second module group to the first low voltage bus via the switch in a first configuration during a first phase of a cycle to transfer a charge between the first module group and the second module group, and couple the second module group to the second low voltage bus via the switch in a second configuration during a second phase of the cycle to transfer charge between the second module group and the third module group to thereby balance the charge in the battery pack.

In addition to one or more of the features described herein, the processor is further configured to determine a balancing current for transferring the charge by minimizing a cost function that includes a sum of the square of charge differences and a sum of the square of balancing currents over a finite cycle horizon.

In addition to one or more of the features described herein, the processor is further configured to determine the balancing currents to minimize an effect of balancing the module groups on at least one of a first low voltage load on the first low voltage bus and a second low voltage load on the second low voltage bus.

In addition to one or more of the features described herein, the processor is further configured to apply a constraint to the cost function and update the constraint for each cycle.

In addition to one or more of the features described herein, the first module group includes a first plurality of module groups and the third module group includes a second plurality of module groups.

In addition to one or more of the features described herein, the number of module groups in the first plurality of module groups is based on a power level in low voltage busses coupled to the module groups.

In addition to one or more of the features described herein, a period of the cycle is fixed.

In yet another exemplary embodiment, a vehicle is disclosed. The vehicle includes a battery pack and a processor. The battery pack includes a first module group coupled to a first low voltage bus, a second module group coupled to a switch, a third module group coupled to a second low voltage bus. The processor is configured to couple the second module group to the first low voltage bus via the switch in a first configuration during a first phase of a cycle to transfer a charge between the first module group and the second module group, and couple the second module groups to the second low voltage bus via the switch in a second configuration during a second phase of the cycle to transfer charge between the second module group and the third module group to thereby balance the charge in the battery pack.

In addition to one or more of the features described herein, the processor is further configured to determine a balancing current for transferring charge by minimizing a cost function that includes a sum of the square of charge differences and a sum of the square of balancing currents over a finite cycle horizon.

In addition to one or more of the features described herein, the processor is further configured to determine the balancing currents which minimize an effect of balancing the module groups on at least one of a first low voltage load on the first low voltage bus and a second low voltage load on the second low voltage bus.

In addition to one or more of the features described herein, the processor is further configured to apply a constraint to the cost function and updating the constraint for each cycle.

In addition to one or more of the features described herein, the first module group includes a first plurality of module groups and the third module group includes a second plurality of module groups.

In addition to one or more of the features described herein, the number of module groups in the first plurality of module groups is based on a power level in low voltage busses coupled to the module groups.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle in accordance with an exemplary embodiment;

FIG. 2 shows a high-level schematic diagram of an electric drive system of the vehicle;

FIG. 3 shows a detailed circuit diagram for the electrical system of the vehicle, in an illustrative embodiment;

FIG. 4 illustrates a switching cycle of the electrical system in an embodiment;

FIG. 5 is a graph of state of charge against time;

FIG. 6 shows a graph of module current over time;

FIG. 7 shows a graph of balancing current over time; and

FIG. 8 shows a graph of regulator currents over time.

### DETAILED DESCRIPTION

The following description is merely exemplary in nature and is not intended to limit the present disclosure, its application or uses. It should be understood that throughout the drawings, corresponding reference numerals indicate like or corresponding parts and features.

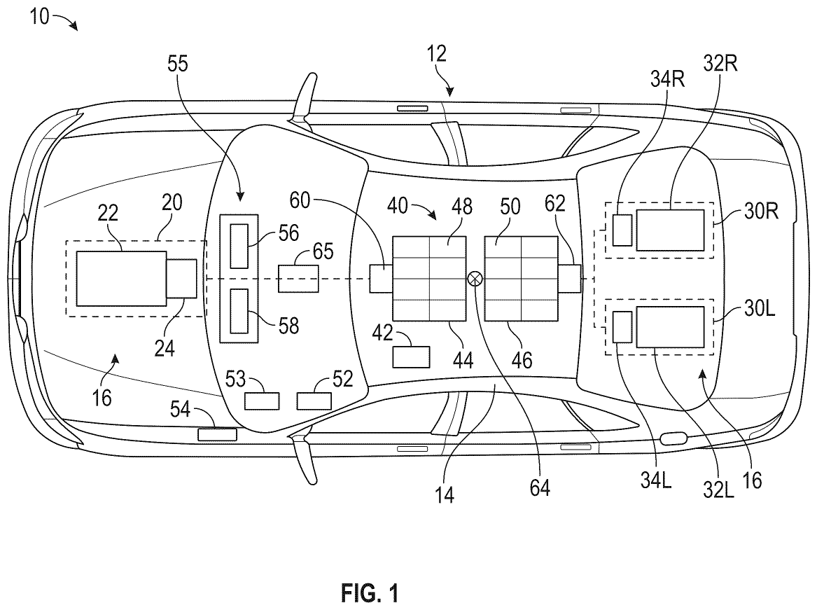

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. The vehicle 10 can be a car, a truck, a van, a bus, a motorcycle, or other type of automobile. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a plurality of battery modules 48, and the second battery pack 46 includes a plurality of battery modules 50. Each battery module 48, 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the electrical system of the vehicle, including the battery system 40, the switching system the drive units, etc. A controller 65 includes any suitable processing device or unit and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may include a non-transitory computer-readable medium that stores instructions which, when processed by one or more processors of the controller 65, implement a method of balancing charge across various battery modules of the vehicle during operation of low voltage loads, according to one or more embodiments detailed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle fueled by gasoline, diesel, etc., a hybrid vehicle partially or wholly powered by electrical power, etc.

As described herein, a vehicle can include one or more electrical loads that are powered by one or more batteries. Exemplary loads include, but are not limited to motors, lights, infotainment equipment, electronic control units, climate control systems, etc. The electrical loads can be high voltage load or low voltage loads, and the battery system 40 (e.g., one or more of the first battery pack 44 and the second battery pack 46) can provide both high voltage to the high voltage loads and low voltage to the low voltage loads. According to one or more embodiments described herein, a high voltage can refer to, but is not limited to, 100 volts, 250 volts, 400 volts, 500 volts, 650 volts, 800 volts, 1000 volts, etc. The low voltage can refer to, but is not limited to, 12 V, 48V etc. To support these low voltage loads, the vehicle 10 can include at least one DC/DC converter to convert DC electric power from the higher voltage to the lower voltage, as disclosed herein.

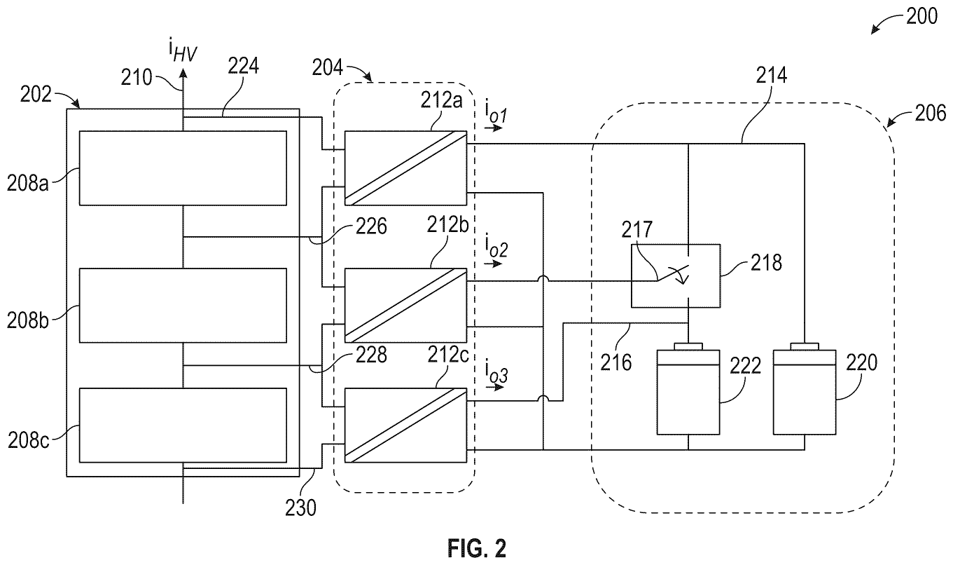

FIG. 2 shows a high-level schematic diagram 200 of an electric drive system of the vehicle 10. The high-level schematic diagram 200 shows a battery pack 202, an array 204 of DC converters and a low voltage power grid 206. The battery pack 202 has a plurality of module groups 208a, 208b, 208c arranged in series along a high voltage bus (HV bus 210). Each module group 208a, 208b, 208c includes a plurality of battery modules (not shown). The array 204 of DC converters includes a plurality of DC/DC converters 212a, 212b, 212c. For illustrative purposes, three module groups are shown. The DC/DC converters can be bidirectional converters.

Each DC/DC converter is coupled across a respective module group of the battery pack 202. For example, a first DC/DC converter 212a is coupled across first module group 208a, a second DC/DC converter 212b is coupled across second module group 208b, and a third DC/DC converter 212c is coupled across third module group 208c. A first conductive wire 224 connects a positive terminal of the first DC/DC converter 212a to the HV bus 210 at an outside end of the first module group 208a. A second conductive wire 226 connects a negative terminal of the first DC/DC converter 212a and a positive terminal of the second DC/DC converter 212b to the HV bus 210 between the first module group 208a and the second module group 208b. A third conductive wire 228 connects a negative terminal of the second DC/DC converter 212b and a positive terminal of the third DC/DC converter 212c to the HV bus 210 between the second module group 208b and the third module group 208c. A fourth conductive wire 230 connects a negative terminal of the third DC/DC converter 212c to the HV bus 210 at an outside end of the third module group 208c.

The low voltage power grid 206 includes a first low voltage bus 214, a second low voltage bus 216 and a switch 218. The first low voltage bus 214 includes a first low voltage load 220 and the second low voltage bus 216 includes a second low voltage load 222. The first low voltage load 220 is electrically coupled to the first module group 208a via the first low voltage bus 214 and the first DC/DC converter 212a. The second low voltage load 222 is electrically coupled to the third module group 208c via the second low voltage bus 216 and the third DC/DC converter 212c.

A fixed end 217 of the switch 218 is connected to the second module group 208b via the second DC/DC converter 212b. A configurable end to the switch 218 can be placed in either a first configuration or a second configuration. In the first configuration, the second module group 208b is electrically coupled to the first low voltage bus 214 and thus also to the first module group 208a via DC/DC converter 212a. This configuration allows a first transfer current to flow between the first module group 208a and the second module group 208b. If a first charge on the first module group 208a is different from a second charge of the second module group 208b, this first transfer current allows for charge transfer between the first module group and the second module group to balance the first charge to the second charge.

In the second configuration, the second module group 208b is electrically coupled to the second low voltage bus 216 and thus to the third module group 208 via DC/DC converter 212c. This configuration allows a second transfer current to flow between the second module group 208b and the third module group 208c. If the second charge on the second module group 208b is different from a third charge of the third module group 208c, this second transfer current allows for charge transfer between the second module group and the third module group to balance the second charge to the third charge.

By flipping the switch 218 between the first configuration and the second configuration, the charge can be balanced across all of the module groups.

It is understood that, in an alternate embodiment, the low voltage power grid 206 can include more than two low voltage busses (and low voltage loads), each low voltage bus being associated with a module group for providing power for the low voltage load. Since one module group (e.g., the second module 208b) is used as a buffer module for transfer of charge, the number of modules is one more than the number of low voltage busses. In another embodiment, the first module group 208a can represent a first plurality of module groups and the third module group 208c can represent a second plurality of module groups. The second module group 208b can serve as a buffer module group used to transfer charge between the first plurality of module groups and the second plurality of module groups via the switch. The number of module groups in the plurality of module groups can be based on a power level in the low voltage busses that are coupled to the module groups.

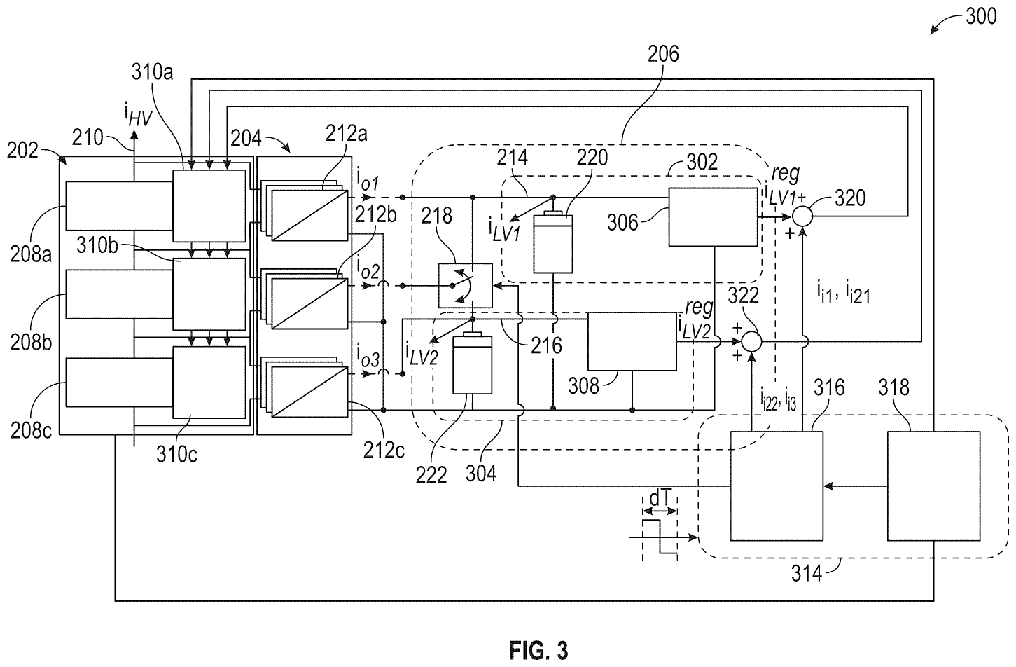

FIG. 3 shows a detailed circuit diagram 300 for the electrical system of the vehicle 10, in an illustrative embodiment. The detailed circuit diagram 300 includes the battery pack 202, the array 204 of DC/DC converters and the low voltage power grid 206.

For illustrative purposes, the low voltage power grid 206 includes a first low voltage grid 302 and a second low voltage grid 304. The first low voltage grid 302 includes the first low voltage load 220 and a first load regulator 306. A first load current i_{LV1} flows through the first low voltage load 220. The first load regulator 306 outputs a first regulator current i^{reg}_{LV1} for DC/DC converters to regulate voltage of the first low voltage grid 302. The second low voltage grid 304 includes the second low voltage load 222 and a second load regulator 308. A second load current i_{LV2} flows through the second low voltage load 222. The second load regulator 308 outputs a second regulator current i^{reg}_{LV2} for DC/DC converters to regulate voltage of the second low voltage grid 304.

The battery pack 202 includes a plurality of module balancing controllers 310a, 310b, 310c. Each module balancing controller is associated with a respective module group (i.e., module balancing controller 310a is associated with module group 208a). Each module balancing controller is used to balance the state of charge (SOC) between the battery modules of its associated module. The module balancing controllers 310a, 310b, 310c receive feedback signals indicative of the first load regulator current (i^{reg}_{LV1}), the second load regulator current (i^{reg}_{LV2}) and an estimation of state of charge and balances the battery modules based on these signals, as disclosed herein.

The detailed circuit diagram 300 further depicts a control circuit 314 that controls operation of the electrical system and, specifically, the operation of the switch 218. The control circuit 314 can be a processor operating one or more algorithms, such as a balance control algorithm 316 and a state of charge estimation algorithm 318. The balance control algorithm 316 outputs a signal for controlling a configuration of the switch 218. In particular, the balance control algorithm 316 sends a signal that flips the switch 218 between the first configuration and the second configuration. The switching occurs over a fixed time period (dT) and thus at a fixed frequency (1/dT).

The balance control algorithm 316 can also output desired currents that can be used as feedback for balancing charges, as disclosed herein. The balance control algorithm 316 outputs commands for balancing currents iᵢ₁ and iᵢ₂₁ to a first summing circuit 320. The first summing circuit 320 adds these currents to the first load regulator current (i^{reg}_{LV1}) and sends the sum to the module balancing controllers 310a, 310b, 310c. Similarly, the balance control algorithm 316 outputs commands for balancing currents iᵢ₃ and iᵢ₂₂ to a second summing circuit 322. The second summing circuit 322 adds these currents to the second load regulator current (i^{reg}_{LV2}) and sends the sum to the module balancing controllers 310a, 310b, 310c.

The state of charge estimation algorithm 318 receives data from sensors that can measure current at the module groups 208a, 208b, 208c or at individual battery modules within the module groups. The state of charge estimation algorithm 318 determines state of charge from these currents and outputs the state of charge values to the module balancing controllers 310a, 310b, 310c and to the balance control algorithm 316. Each module balancing controller 310a, 310b, 310c balances the state of charge between the battery modules of the selected module group. The balance control algorithm 316 controls the configuration of the switch 218 based on the state of charge values.

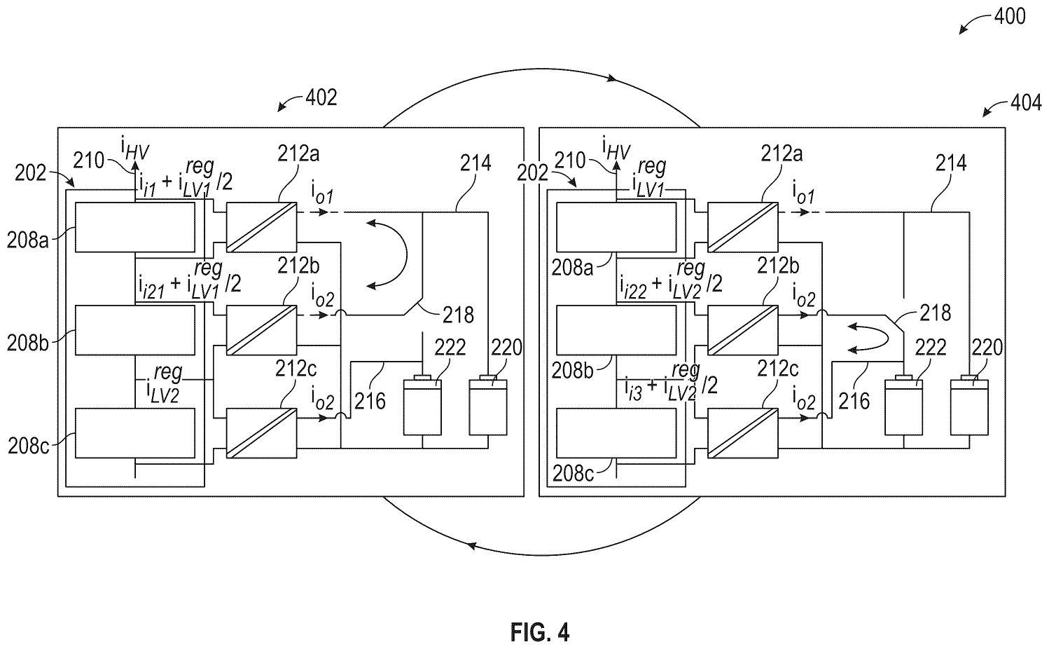

FIG. 4 illustrates a switching cycle 400 of the electrical system in an embodiment. The switching cycle 400 includes a first phase 402 and a second phase 404. The first phase 402 shows the electrical system with the switch 218 connecting the first module group 208a and the second module group 208b via the first low voltage bus 214. A second phase 404 shows the electrical system with the switch 218 connecting the second module group 208b and the third module group 208c via the second low voltage bus 216. The electrical system cycles back and forth between the first phase 402 and the second phase 404 at frequency 1/dT with the electrical system being in the first phase 402 for half of a period (0.5*dT) and in the second phase 404 for half of the period (0.5*dT).

In the first phase 402, the balancing currents iᵢ₁ and i₂₁ are provided in the circuit. A current

$${i}_{i 1} + \frac{1}{2} {i}_{L V 1}^{r e g}$$

is supplied to the first DC/DC converter 212a. A current

$${i}_{i 21} + \frac{1}{2} {i}_{L V 1}^{r e g}$$

is supplied to the second DC/DC converter 212b. A current i^{reg}_{LV2} is supplied to the third DC/DC converter 212c.

In the second phase 404, the balancing currents iᵢ₃ and i₂₂ are provided in the circuit. A current i^{reg}_{LV1} is supplied to the first DC/DC converter 212a, a current

$${i}_{i 22} + \frac{1}{2} {i}_{L V 2}^{r e g}$$

is supplied to the second DC/DC converter 212b, and a current

$${i}_{i 3} + \frac{1}{2} {i}_{LV 2}^{r e g}$$

is supplied to the third DC/DC converter 212c.

The average charge on the first module group 208a at a given time step k+1 is related to the average charge at the previous time step k as shown in Eq. (1):

$${q}_{1} ( k + 1 ) = {q}_{1} ( k ) - {h}_{H V} ( {i}_{i 1} ( k ) + {i}_{H V} ( k ) + \frac{3}{4} {i}_{L V 1}^{r e g} ( k ) ) d T \qquad Eq . ( 1 )$$

where q₁(k+1) is the state of charge at the first module group 208a at time step k+1, q₁(k) is the state of charge at time step k, h_{HV} is the reciprocal of the capacitance of the battery pack 202, iᵢ₁ is the balancing current along the first low voltage bus 214 during the first phase 402, i_{HV} is the current along the high voltage bus, and i^{reg}_{LV1} is the first regulator current from the first load regulator 306. The parameter dT is the duration or period of a switching cycle.

Similarly, the average charge on the second module 208b is shown in Eq. (2):

$${q}_{2} ( k + 1 ) = {q}_{2} ( k ) - {h}_{H V} ( {i}_{i 21} ( k ) + {i}_{i 22} ( k ) + {i}_{H V} ( k ) + \frac{1}{4} ( {i}_{L V 1}^{r e g} ( k ) + {i}_{L V 2}^{r e g} ( k ) ) ) d T \qquad Eq . ( 2 )$$

where q₂(k+1) is the state of charge at the second module group 208b at time step k+1, q₂(k) is the state of charge at time step k, i₂₁ is a balancing current between the first module group 208a and the second module group 208b during the first phase 402. i₂₂ is a second balancing current between the second module group 208b and the third module group 208c during the second phase 404, and i_{LV2}^{reg} is the second regulator current from the second load regulator 308.

Similarly, the average charge on the third module 208c is shown in Eq. (3):

$${q}_{3} ( k + 1 ) = {q}_{3} ( k ) - {h}_{H V} ( {i}_{i 3} ( k ) + {i}_{H V} ( k ) + \frac{3}{4} {i}_{LV 2}^{r e g} ( k ) ) d T \qquad Eq . ( 3 )$$

where q₃(k+1) is the state of charge at the third module group 208c at time step k+1, q₃(k) is the state of charge at time step k and iᵢ₃ is the current from the third module group 208c.

The switch 218 is operated to minimize a cost function including J quadratic costs over a finite cycle horizon N, as shown in Eq. (4):

$$J = {\sum }_{k = 1}^{N} ( y ( k ) + {R}_{u} ( k ) ) \qquad Eq . ( 4 )$$

where the term y(k) is a square of the differences in the charges on the module groups 208a-208c, as shown in Eq. (5):

$$y ( k ) = {( {q}_{1} ( k ) - {q}_{2} ( k ) )}^{2} + {( {q}_{2} ( k ) - {q}_{3} ( k ) )}^{2} + {( {q}_{3} ( k ) - {q}_{1} ( k ) )}^{2} \qquad Eq . ( 5 )$$

and the term Rᵤ(k) is the sum of the squares of the balancing currents, as shown in Eq. (6):

$${R}_{u} ( k ) = R \times {\sum }_{j = 1}^{3} {i}_{i j}^{2} ( k ) \qquad Eq . ( 6 )$$

The quadradic cost J can be minimized using constraints that are selected to avoid damage to the battery pack 202. The constraints can be updated at each cycle or time step k. Exemplary constraints are shown in Eqs. (7)-(9):

$$max ( - {i}_{1}^{max} + {i}_{H V} ( k ) , - {i}_{D C 1}^{max} ( k ) ) \leq {i}_{i 1} ( k ) \leq min ( - {i}_{1}^{min} + {i}_{H V} ( k ) , - {i}_{D C 1}^{max} ( k ) ) \qquad Eq . ( 7 )$$

$$max ( - {i}_{2}^{max} + {i}_{H V} ( k ) , - {i}_{D C 2}^{max} ( k ) ) \leq {i}_{i 2 j} ( k ) \leq min ( - {i}_{2}^{min} + {i}_{H V} ( k ) , - {i}_{D C 2}^{max} ( k ) ) j = 1 , 2 \qquad Eq . ( 8 )$$

$$max ( - {i}_{3}^{max} + {i}_{H V} ( k ) , - {i}_{D C 3}^{max} ( k ) ) \leq {i}_{i 3} ( k ) \leq min ( - {i}_{3}^{min} + {i}_{H V} ( k ) , - {i}_{D C 3}^{max} ( k ) ) \qquad Eq . ( 9 )$$

where iₓ^{max} is a maximum possible current through an x^{th} module, i_{z}^{min} is a minimum possible current through an x^{th} module i_{DCx}^{max} is a maximum current allowed for DC/DC converter in either current direction

The balancing current can be selected to minimize the effect of balancing of the module groups on the low voltage loads as detected at the LV regulators, as shown in Eqs. (10)-(11):

$$\frac{{V}_{1} ( k )}{{V}_{L V 1} ( k )} {i}_{i 1} ( k ) + \frac{{V}_{2} ( k )}{{V}_{LV 1} ( k )} {i}_{i 21} ( k ) = 0 \qquad Eq . ( 10 )$$

$$\frac{{V}_{3} ( k )}{{V}_{LV 2} ( k )} {i}_{i 3} ( k ) + \frac{{V}_{2} ( k )}{{V}_{L V 2} ( k )} {i}_{i 22} ( k ) = 0 \qquad Eq . ( 11 )$$

where V₁ is voltage of the first module group 208a, V₂ is the voltage of the second module group 208b and V₃ is the voltage of the third module group 208c, V_{LV1} is voltage of the first low voltage bus 214, and V_{LV2} is voltage of the second low voltage bus 216.

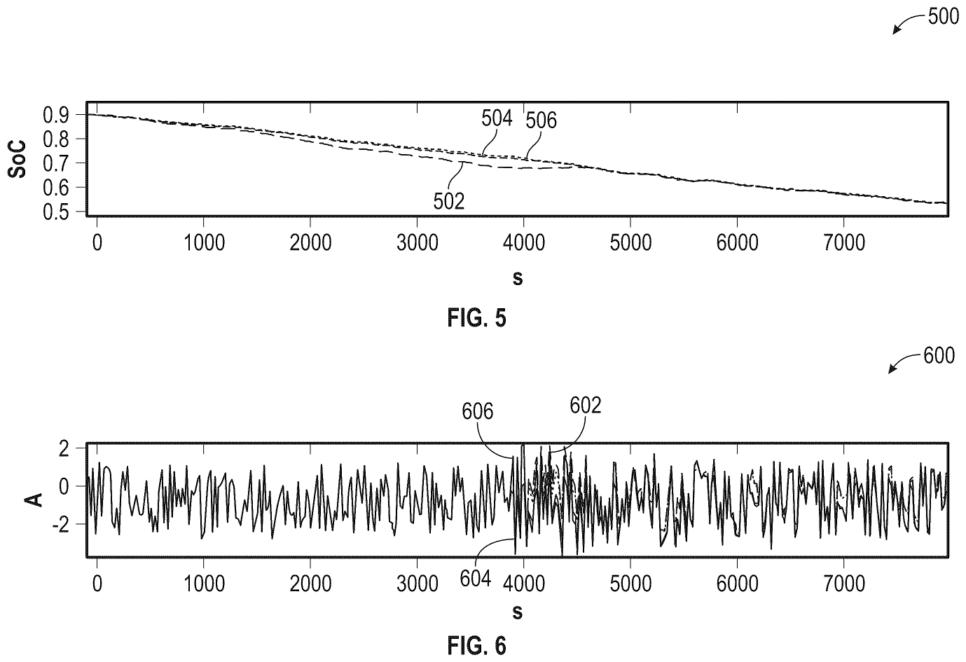

FIG. 5 is a graph 500 of state of charge against time. Time is shown along the abscissa in seconds (s) and normalized SOC is shown along the ordinate axis, wherein the value of SOC=1 refers to a fully charged module and SOC=0 is a fully discharged module. The SOCs of the modules are initially balanced (i.e., same SOC at time t=0 seconds). The modules are operated up until about time t=3900 seconds without using the charge balancing operation disclosed herein. Over time, the SOCs of the modules diverge, as shown by the divergence between first SOC 502 of the first module group 208a, second SOC 504 of the second module group 208b, and third SOC 506 of the third module group 208c. At time t=3900 seconds, the change balancing operation disclosed herein is implemented. The first SOC 502, second 50C 504 and third SOC 506 soon converge to a same value (i.e., within about 500 seconds).

FIG. 6 shows a graph 600 of module current over time. The module current is the sum of the high voltage bus current and a selected balancing current. Time is shown along the abscissa in seconds and module current is shown along the ordinate axis in amps. From the initial time to the time at which the balancing operation disclosed herein is implements (about t=3900 seconds), the current is the same through the module groups. After t=3900 seconds, the current of each module is different, as shown by first current curve 602 (first module group 208a), second current curve 604 (second module group 208b) and third current curve 606 (third module group 208c).

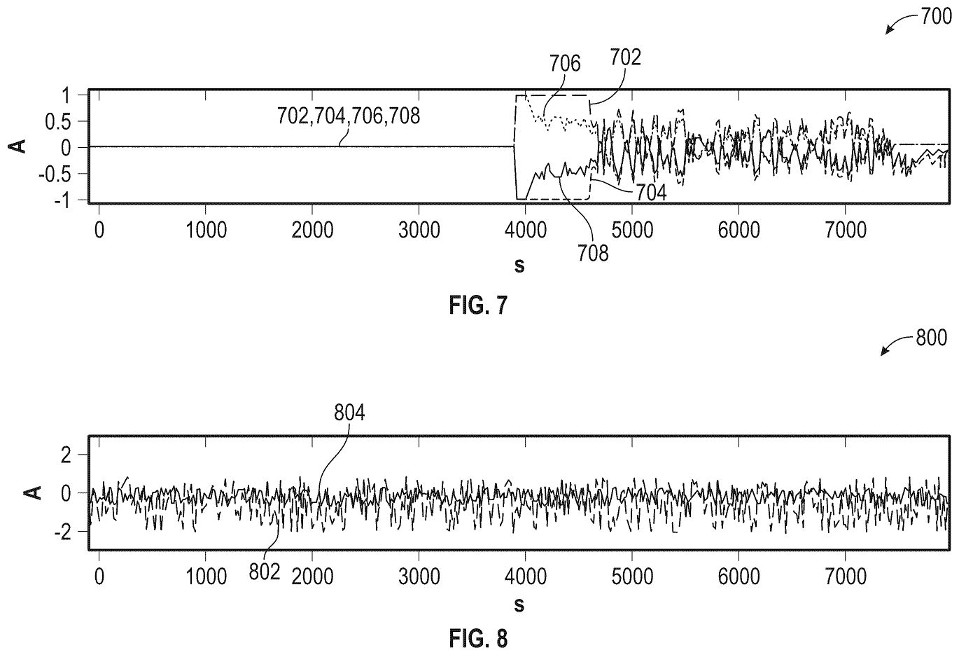

FIG. 7 shows a graph 700 of balancing current over time. Time is shown along the abscissa in seconds and balancing current is shown along the ordinate axis in amps. From the initial time to the time at which the balancing operation disclosed herein is implemented (about t=3900 seconds), the balancing current is the same through the module groups. After t=3900 seconds, the current of each module is different, as shown by first balancing current curve 702 (first module group 208a), second balancing current curve 704 (between the first module group 208a and the second module group 208b) third balancing current curve 606 (between the second module group 208b and the third module group 208c) and fourth balancing current curve 708 (third module group 208c).

FIG. 8 shows a graph 800 of regulator currents over time. Time is shown along the abscissa in seconds and regulator current is shown along the ordinate axis in amps. The first regulator current i^{reg}_{LV1} is shown in first curve 802 and the second regulator current i^{reg}_{LV2} is shown in second curve 804.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of balancing charge in a battery pack;
coupling a first module group to a first low voltage bus;
coupling a second module group to a switch;
coupling a third module group to a second low voltage bus;
coupling, via the switch in a first configuration during a first phase of a cycle, the second module group to the first low voltage bus to transfer a charge between the first module group and the second module group; and
coupling, via the switch in a second configuration during a second phase of the cycle, the second module group to the second low voltage bus to transfer the charge between the second module group and the third module group to thereby balance the charge in the battery pack.

2. The method of claim 1, further comprising determining a balancing current for transferring the charge by minimizing a cost function that includes a sum of the square of charge differences and a sum of the square of balancing currents over a finite cycle horizon.

3. The method of claim 2, further comprising determining the balancing currents which minimize an effect of balancing the module groups on at least one of a first low voltage load on the first low voltage bus and a second low voltage load on the second low voltage bus.

4. The method of claim 2, further comprising applying a constraint to the cost function and updating the constraint for each cycle.

5. The method of claim 1, wherein the first module group includes a first plurality of module groups and the third module group includes a second plurality of module groups.

6. The method of claim 5, wherein the number of module groups in the first plurality of module groups is based on a power level in low voltage busses coupled to the module groups.

7. The method of claim 1, wherein a period of the cycle is fixed.

8. A battery pack of a vehicle, comprising;
a first module group coupled to a first low voltage bus;
a second module group coupled to a switch;
a third module group coupled to a second low voltage bus;
a processor configured to:
couple, via the switch in a first configuration during a first phase of a cycle, the second module group to the first low voltage bus to transfer a charge between the first module group and the second module group; and
couple, via the switch in a second configuration during a second phase of the cycle, the second module group to the second low voltage bus to transfer charge between the second module group and the third module group to thereby balance the charge in the battery pack.

9. The battery pack of claim 8, wherein the processor is further configured to determine a balancing current for transferring the charge by minimizing a cost function that includes a sum of the square of charge differences and a sum of the square of balancing currents over a finite cycle horizon.

10. The battery pack of claim 9, wherein the processor is further configured to determine the balancing currents to minimize an effect of balancing the module groups on at least one of a first low voltage load on the first low voltage bus and a second low voltage load on the second low voltage bus.

11. The battery pack of claim 9, wherein the processor is further configured to apply a constraint to the cost function and update the constraint for each cycle.

12. The battery pack of claim 8, wherein the first module group includes a first plurality of module groups and the third module group includes a second plurality of module groups.

13. The battery pack of claim 12, wherein the number of module groups in the first plurality of module groups is based on a power level in low voltage busses coupled to the module groups.

14. The battery pack of claim 8, wherein a period of the cycle is fixed.

15. A vehicle, comprising;
a battery pack comprising:
a first module group coupled to a first low voltage bus;
a second module group coupled to a switch;
a third module group coupled to a second low voltage bus;
a processor configured to:
couple, via the switch in a first configuration during a first phase of a cycle, the second module group to the first low voltage bus to transfer a charge between the first module group and the second module group; and
couple, via the switch in a second configuration during a second phase of the cycle, the second module groups to the second low voltage bus to transfer charge between the second module group and the third module group to thereby balance the charge in the battery pack.

16. The vehicle of claim 15, wherein the processor is further configured to determine a balancing current for transferring charge by minimizing a cost function that includes a sum of the square of charge differences and a sum of the square of balancing currents over a finite cycle horizon.

17. The vehicle of claim 16, wherein the processor is further configured to determine the balancing currents which minimize an effect of balancing the module groups on at least one of a first low voltage load on the first low voltage bus and a second low voltage load on the second low voltage bus.

18. The vehicle of claim 16, wherein the processor is further configured to apply a constraint to the cost function and updating the constraint for each cycle.

19. The vehicle of claim 15, wherein the first module group includes a first plurality of module groups and the third module group includes a second plurality of module groups.

20. The vehicle of claim 19, wherein the number of module groups in the first plurality of module groups is based on a power level in low voltage busses coupled to the module groups.
